(19) United States
(12) Patent Application Publication
(10) Pub. No.: US 2013/0325647 A1
(43) Pub. Date: Dec. 5, 2013

(54) VIRTUAL MARKETPLACE ACCESSIBLE TO WIDGETIZED AVATARS

(71) Applicant: FUHU HOLDINGS, INC., (US)

(72) Inventor: Robb Fujioka, Manhattan Beach, CA (US)

(73) Assignee: FUHU HOLDINGS, INC., El Segundo, CA (US)

(21) Appl. No.: 13/891,147

(22) Filed: May 9, 2013

Related U.S. Application Data
(63) Continuation of application No. 12/701,000, filed on Feb. 5, 2010, now abandoned.
Application No. 12/701,000 is a continuation-in-part of application No. 12/628,046, filed on Nov. 30, 2009.
Application No. 12/628,046 is a continuation-in-part of application No. 12/592,207, filed on Nov. 20, 2009, now Pat. No. 8,533,610.
Application No. 12/592,207 is a continuation-in-part of application No. 12/381,663, filed on Mar. 13, 2009.
(60) Provisional application No. 61/207,980, filed on Feb. 17, 2009.

(51) Int. Cl. G06Q 30/06

(52) U.S. Cl. CPC G06Q 30/0621; G06Q 30/0643
USPC 705/26.5; 705/27.2

(57) ABSTRACT

A system for creating and providing clothing and accessories for avatars, including within a virtual marketplace is disclosed. The system includes computer programming resident on at least one networked server, wherein the computer programming provides a creation tool and an online marketplace having at least one virtual storefront. A user access to the online marketplace includes a user-directed, computer programmable avatar, and further includes a computing device communicatively connected to the at least one networked server.

### CROSS REFERENCE TO RELATED APPLICATIONS

This application is a continuation of U.S. patent application Ser. No. 12/701,000 titled “Virtual Marketplace Accessible To Widgetized Avatars,” filed Feb. 5, 2010 by inventor Robb Fujioka, the contents of which are expressly incorporated herein by this reference as though set forth in their entirety, and to which priority is claimed. U.S. patent application Ser. No. 12/701,000 is a continuation-in-part of U.S. patent application Ser. No. 12/628,046, titled “A Virtual Marketplace Accessible To Widgetized Avatars,” filed Nov. 30, 2009. U.S. patent application Ser. No. 12/628,046 claims the benefit under 35 U.S.C. 119(e) of U.S. Patent Application No. 61/207,980, titled “System And Method For Providing Expert Search In A Modular Computing System,” filed Feb. 17, 2009, and is a continuation-in-part of U.S. patent application Ser. No. 12/592,207, titled “A Widgetized Avatar And A Method And System Of Creating And Using Same” filed Nov. 20, 2009, which is a continuation of U.S. patent application Ser. No. 12/381,663, titled “A Widgetized Avatar And A Method And System Of Creating And Using Same” and filed Mar. 13, 2009, the entire disclosures of which are incorporated by reference herein as if each being set forth in their entirety.

### FIELD OF INVENTION

The present invention is directed to avatars for use in computing communities and, more particularly, to the creation of clothing and accessories for avatars and a virtual marketplace accessible to widgetized avatars for conducting virtual and real world commerce.

### BACKGROUND

Many computing and entertainment embodiments allow for a user, player, or viewer to create an “avatar.” An avatar is typically a virtual manifestation of that user's “computerized physicality.” However, the prior art typically provides only limited options for a user who wishes to create an avatar, such as limited physical features, clothing, associated information, and the like. As such, a typical avatar allows for only very limited information about a user to be relayed by the avatar. More specifically, the physical characteristics of the avatar likely have only limited applicability to the physicality of the real-world user, due in part to the limited physical, clothing and the like options available in creating the avatar, and the typical information associated with the avatar, other than its physicality, is limited or non-existent.

Additionally, users of avatar based systems, and/or avatar creative and design systems, often lack the necessary access and/or experience to produce custom clothing and accessories. Present systems are largely in use by experts in the field of avatars, and/or graphical designers of virtual clothing and accessories, and thus do not allow an opportunity for non-expert users to create custom clothing and accessory designs.

Thus, the need exists for an apparatus, system and method, that allows for the creation of clothing and accessories for avatars, as well as an improved virtual marketplace for increased marketing, monetization and transaction opportunities related to the user's avatar.

### BRIEF SUMMARY OF THE INVENTION

A system for performing online commerce within a virtual marketplace is disclosed. The system includes computer programming resident on at least one networked server, wherein the computer programming provides an online marketplace having at least one virtual storefront. A user access to the online marketplace includes a user-directed, computer programmable avatar, and further includes a computing device communicatively connected to the at least one networked server. An operator of the at least one virtual storefront provides an auction transaction for at least one item with the user directed avatar.

### BRIEF DESCRIPTION OF THE DRAWINGS

Understanding of the present invention will be facilitated by consideration of the following detailed description of the preferred embodiments of the present invention taken in conjunction with the accompanying drawings, in which like numerals refer to like parts:

FIG. 1 illustrates an avatar in accordance with the present invention;

FIG. 2 illustrates an avatar in accordance with the present invention;

FIG. 3 illustrates an avatar in accordance with the present invention;

FIG. 4 illustrates a plurality of avatars in accordance with the present invention; and

FIG. 5 illustrates a flow diagram in accordance with the present invention

FIG. 6 illustrates a selection step in the creation of avatar goods in accordance with the present invention;

FIG. 7 illustrates a selection step in the creation of avatar goods in accordance with the present invention;

FIG. 8 illustrates a selection step in the creation of avatar goods in accordance with the present invention; and

FIG. 9 illustrates an importation step in the creation of avatar goods in accordance with the present invention;

FIG. 10 illustrates an importation step in the creation of avatar goods in accordance with the present invention;

FIG. 11 illustrates an importation step in the creation of avatar goods in accordance with the present invention; and

FIG. 12 illustrates a step in the creation of avatar goods in accordance with the present invention.

### DETAILED DESCRIPTION OF THE DRAWINGS

It is to be understood that the figures and descriptions of the present invention have been simplified to illustrate elements that are relevant for a clear understanding of the present invention, while eliminating, for the purpose of clarity, many other elements found in typical avatar and computing apparatuses, systems and methods. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

An avatar is understood by one of ordinary skill in the art to include a computer user's representation of him or herself, such as in the form of a two or three dimensional model used in computer games, social network applications, or other on-line communities. A typical avatar may further include, or have associated therewith, a user's name, a user's screen name, a handle, or text of interest, such as a trademark, saying, or poem, for example.

A widget in accordance with the present invention, and as will be understood by one of ordinary skill in the art, is a portable portion of code that may be installed or executed within any separate HTML based webpage by an end user without necessitating additional compilation of that code portion. Such widget code portions, in accordance with the present invention, are embeddable by the end user. As such, a widget in accordance with the present invention is any code portion that may be embedded by the end user within a selected page of HTML, XML, or like code that causes presentation of that selected web page. The widget, via the embedded code portion, thereby adds non-static content to the subject webpage.

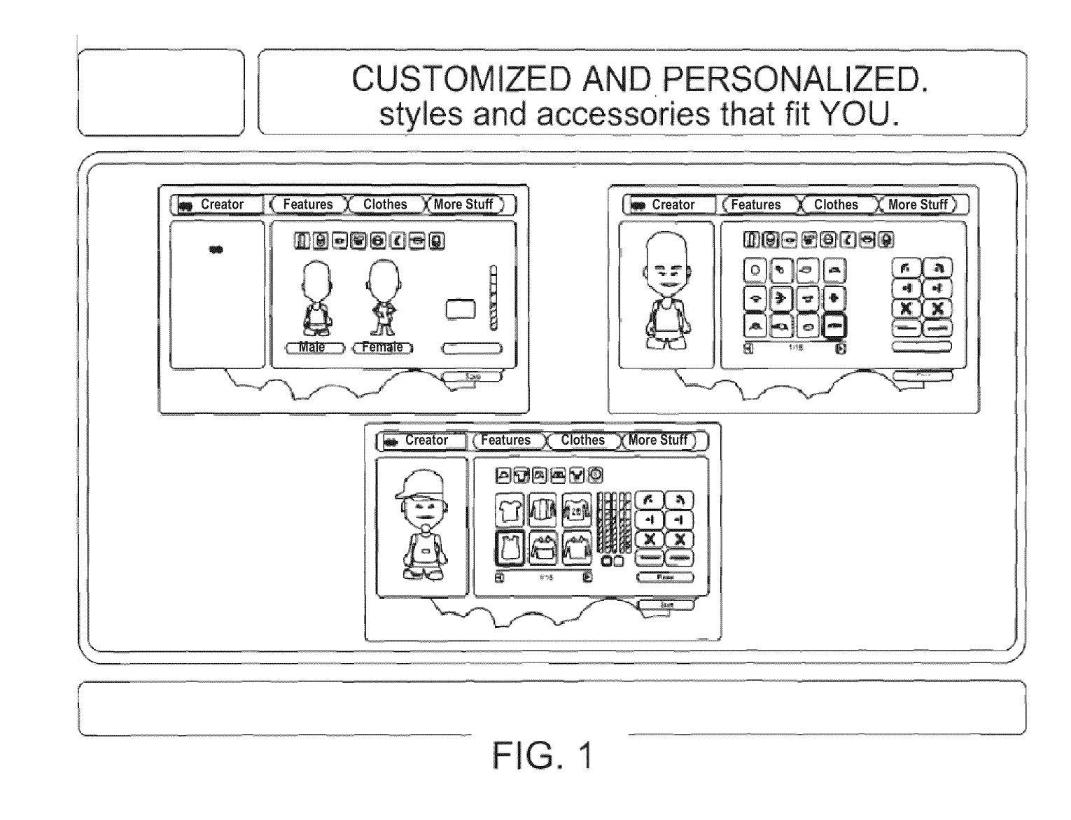

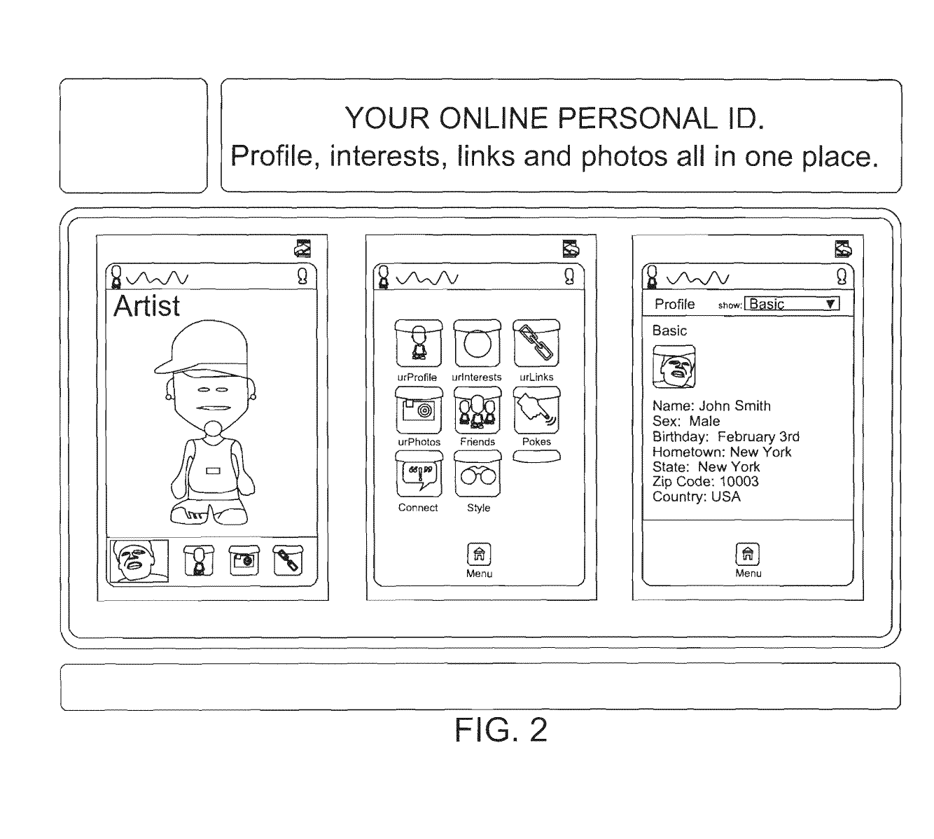

The present invention includes a fully portable, widgetized avatar having associated therewith multiple items of social information that are generally requested for association with at least two different computing communities or transactions. Widgetization of the avatar of the present invention necessarily allows for portability of the avatar of the present invention. For example, creation of a typical avatar in accordance with the present invention may include the association of physical features, such as facial and hair, with the subject avatar, as well as the aforementioned user name, as shown in FIG. 1. Further, a myriad of additional information may be associated with the avatar, wherein such information is generally required or desired for use in computing communities or transactions. This information may be organized into multiple levels of detail, and/or multiple levels of accessibility to third parties in a computing community or transaction. Such levels of accessibility may be selected by the creator of the widgetized avatar based on characteristics of the third party endeavoring to access the subject avatar. For example, a user may have basic information, which may be selectable for viewing by all registered users of a particular community, as shown in FIG. 2.

In an exemplary embodiment, a user may have likes or dislikes, such as musical or motion picture tastes, job or educational status, age, location, income, marital status, and other computed communities with which that user is associated, associated with his or her avatar. The present invention provides a physical manifestation of all of this information, such as in a “trading card” format. For example, FIG. 2 illustrates an avatar wherein the front of the virtual trading card includes an avatar having particular physical features, clothing, accessories, activities, and the like, along with an associated user name. However, when an interaction, such as selection of a drop-down menu, selection of a link, a double click, or the like is undertaken to “flip” a trading card to the back, a myriad of additional information is displayed regarding the user related to the widgetized avatar, such as age, interests, likes and dislikes, employment status, and the like.

Needless to say, because the virtual manifestation of the physical trading card is embodied in the computing code that provides for the virtual manifestation, such computing code may be provided in such a normalized format that it is easily adopted into multiple computing communities or environments, and/or may be adopted as non-static content onto multiple different web pages. As such, the subject avatar may be incorporated into multiple social communities, fantasy sports communities, blogs, and the like. Further, avatars of particular interest to the general public, such as trading card avatars of musical artists or other famous persons, may be downloaded or referenced by fans of such famous persons. Such avatars may, in fact, be presented in non-classical formats, such as through a tab presentation on a web page designed by the user as a home page in a certain community, or that is set forth by a particular computing community. Such “celebrity” avatars, including in such non-classical formats, may include presentations or allow for interactions with celebrity suggestions or favorites, such as recipes, music, concerts, movies, talk shows, reality shows, or the like, and may further allow for purchases from or related to such suggestions or favorites.

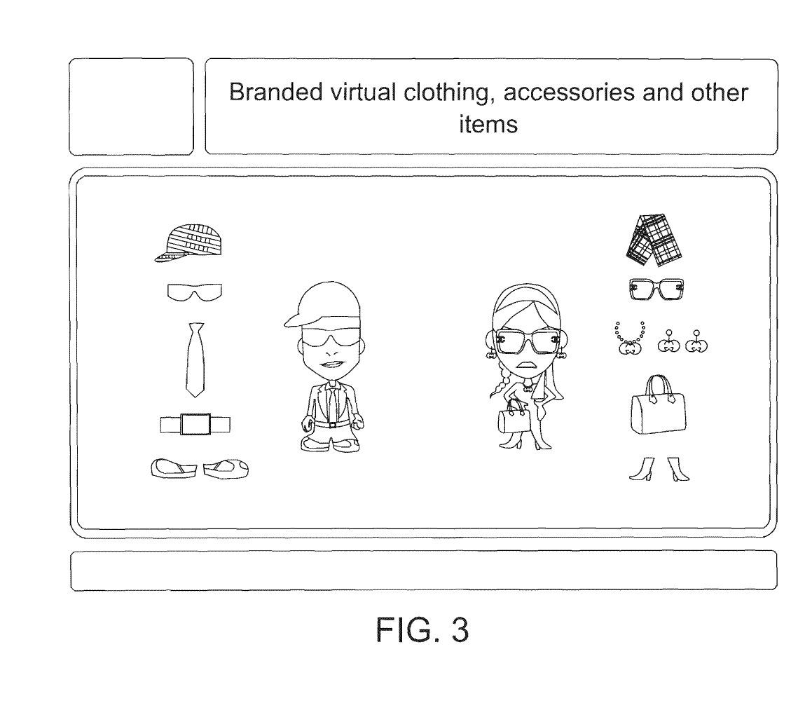

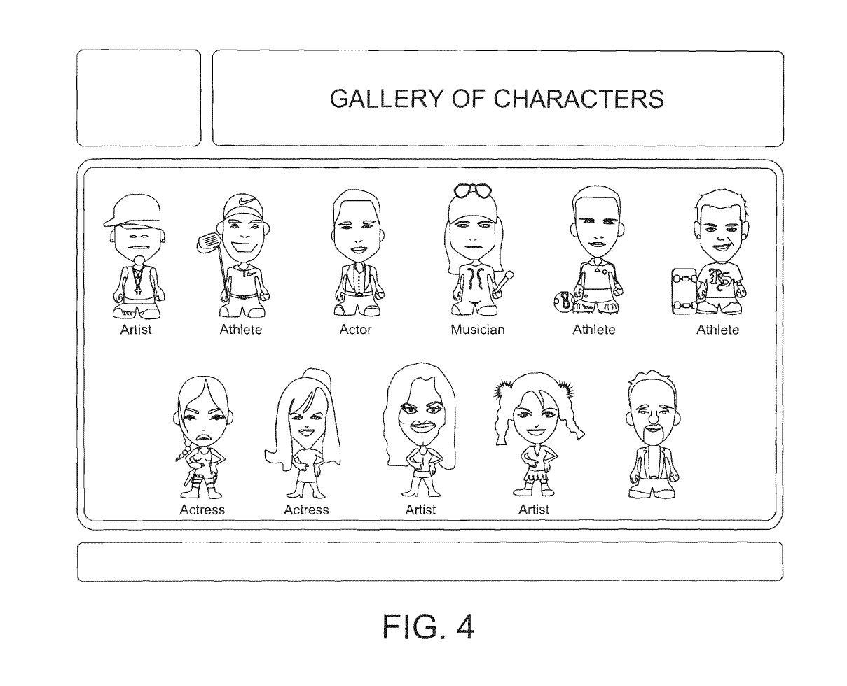

As referenced hereinabove, a typical avatar may have associated therewith certain physical features, clothing, accessories or activities, for example. As such, the present invention is and includes a tool whereby such physical features, clothing, accessories, and activities may be taken from the real world and “virtualized,” for use with a subject avatar, as shown in FIG. 3. For example, famous clothing lines, such as Vera Wang clothing, or famous shoe lines, such as Nike sneakers, or famous accessories, such as Kate Spade purses, or well known activities, such as playing for the Philadelphia Phillies, and goods at well known retailers, such as Tiffany's, Macy's, or the like, may be virtualized for use with an avatar. As such, virtualized items may be made available for sale for use with an avatar just as the corresponding real items are generally for sale for use with the real world user correspondent to the avatar. Likewise, celebrity avatars may be presented as “model” widgetized avatars, and the user may be enabled to purchase those items worn by the celebrity's avatar, and/or that are endorsed by that celebrity, as shown in FIG. 4.

Thereby, for example, during or following creation of a discreet widgetized avatar and/or a widgetized avatar to be associated with the aforementioned avatar trading card, the user creating the avatar may have available a selectable library of options for association with the subject avatar, such as a searchable library of options searchable by key word, or a hierarchal library of options presented by topic. Such libraries may be presented as “stores,” for example, in which the avatar may “shop.” For example, for “fashion”, a user may enter a fashion “shopping” environment, such as a virtual “mall,” to be presented with available virtual clothing lines for the avatar. Such lines may be visually presented by piece of clothing, or pieces of clothing on a shelf, for example, as would be the case in a real-world shopping for the real world user correspondent o the avatar. For example, for “shirts”, the user may be presented with options such as Jones New York, Tommy Hilfiger, Fubu, Major League Baseball, National Football League, and the like, and such options may be presented as storefronts, for example. The user may then select one of the presented fashion shopping points for shirts, and then may be presented with the entire line of “real world” shirts associated with that fashion line, but, of course in a virtualized format. Thus, for example, upon selection of a Major League Baseball store, the user may be presented with a series of major league baseball team jerseys for association with that user's avatar. Needless to say, the user may then select the baseball jersey of that user's favorite team, and may in fact pay, such as through the use of a micropayment, for the use of that virtual jersey just as the user might pay for the purchase of a real world jersey of that user's favorite baseball team in a real world store. Similarly, lines of pants, dresses, suits, shoes, and the like may be made available for use with avatars, and may in fact be made available for purchase by users for use with avatars. Likewise, accessories or activities that would require purchase in the real world by the user may additionally allow for purchase of such accessories or activities in the virtual world for use with the user's widgetized avatar.

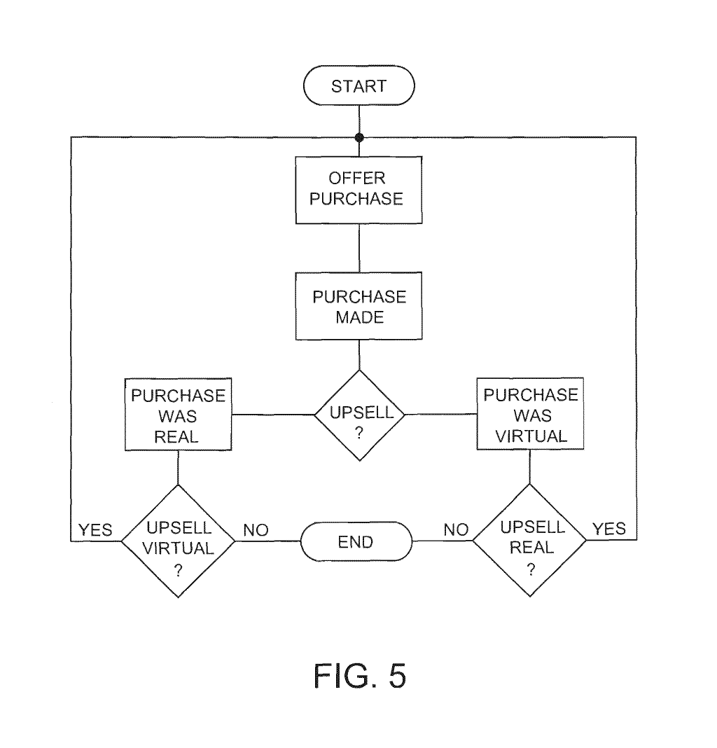

Additionally, the present invention may provide an up sell engine as illustrated in FIG. 5. The upsell engine may operate, upon purchase of a virtual item for association with the user's avatar, may present the user with an opportunity to purchase the same or similar article in the real world for real world use by the actual user based on that user's known preference for that article as evidenced by the purchase of the virtual article for use with the user's avatar. This may, of course, occur within an online store correspondent to the virtual store in which the avatar was “shopping.” The upsell engine may additionally or alternatively include presentation to the user of an advertisement for real world articles that are the same as or associated with the virtual article purchased by the user, or may allow for presentation of advertising related to likely related virtual or real world articles of interest to the user based on the user's expressed preference for the particular virtual article selected. Needless to say, the present invention may also be used to upsell in the inverse situation—that is, the situation in which the user purchases a real world article from a particular web site, or surfs a particular web site for real world goods and/or services, may cause the user to be presented with advertising for the purchase of the same or similar virtual articles, or associated or related virtual articles, or to be presented with a direct opportunity to purchase the same, similar, or related virtual articles at the point of purchase of the particular real world article.

Further, the present invention may allow for association of particular levels of expertise with particular areas of interest as related to the avatar trading card. As such, the user associated with the subject avatar may take a rating of that user's expertise in certain areas from computing community to computing community. Thus, searches may be made available in one or more computing communities for persons having desired levels of expertise in certain areas. The user may thus accumulate expertise points in multiple computing communities at the same time, wherein such points may be associated with that user's transferable widgetized avatar, whereby a user's expertise may rise based on accumulated expertise points. Additionally and alternatively, a user's expertise in a certain area may increase based on feedback from other users in one or more computing communities in relation to the subject users expertise in a particular area, or a user's expertise may increase based on an assignment of expertise levels by one or more of the computing communities, or a user's expertise level may rise based on advice offered, amount of advice offered, or purchase of expertise or advice from that user in or more on-line computing communities. Thus, a search by a party in need, such as a key word search, for an expert in a particular area may not return a user advertising to be an expert in a particular area, but instead may return a user adjudged to be an expert in a particular area by parties other than that user him or himself. Of course, in accordance with the present invention, such expertise levels may be associated with the avatar or avatar trading card, and as such may be subsequently transferred to other computing communities.

Thus, the avatar of the present invention enables a user to create a portable, fully virtual “person” for association with that user and carrying the characteristics of that user, including a personal profile and identification card that can be used in combination with any web page, webtop or desktop and any computing community, transaction or social networking situation. Thereby, the avatar of the present invention allows users to connect with other users and share ideas, content, expertise, and applications. Further, the avatar of the present invention thus assists in viral growth by offering users of certain or multiple computing communities an avatar that keeps all personal profile information in one transportable place. Additionally, the avatars of the present invention may provide a foundation for a recommendation and expertise engine employing an algorithm that may suggest content or an expert based on a user's community, popularity, known expertise, clicks, interests, searches, or the like.

The avatar of the present invention may include one or more of the user profile, physicality of avatar, user personal characteristics, user interests, user links, user photos, videos, or audio, user friends, user sayings, jokes, or the like, user notes, connections or message postings, and user clothing, accessories, activities and general style. As used herein, the computing communities and transactions to which the avatar of the present invention may be transferred include all computing communities, including telecommunications communities such as those accessible from cellular telephones, televisions, and the like.

Accordingly, virtual communities, such as a virtual mall, may be created in accordance with the present invention. A virtual mall may be equipped with a myriad of virtual “stores,” such stores having virtual, on-screen storefronts that may allow a user, such as via the aforementioned avatar, to virtually enter and shop at the store. Such stores may be mobile “widgets,” in a manner similar to the avatar discussed above, and as such may be placed in numerous online locations or communities, or may form a permanent part of a DNS mall location or community, for example. A user may shop within a virtual mall using an avatar or other similar online persona, as described hereinabove. Such an avatar may, for example, select a body type and/or style. Further, hair type, color and style have selected therefore clothing. This clothing may include tops, bottoms, shoes and accessories purchased at virtual stores that is, the online persona may mimic accessories and clothing accessible in a real world environment to the user.

As such, a virtual mall may present an online social community. This parallels the concept of a real world mall as a social networking point. The virtual mall of the present invention may be an extension of shopping as a social activity. Thus, a virtual mall may provide shopping, as well as a place to interact with friends, or to obtain and/or purchase entertainment.

The virtual mall may be presented as an outdoor mall, and/or may include mechanisms of a real world mall such as elevators, escalators, shuttles, hallways, movie theaters, food courts and the like. Similarly the virtual mall may take the form of an indoor mall, and/or may include with many levels of shopping. Alternatively, the virtual mall may take the form of a fantasy location, such as underwater, in outer space, or on the surface of the sun or moon, for example.

Users may browse through a virtual store in a manner similar to browsing in a real store. An avatar may enter different stores and look through merchandise. Such merchandise may be categorized based on a user query, or simply visible on-screen by type, for example. The virtual mall may thus provide virtual and/or online shopping, social networking, multiplayer games, movies and entertainment and the like. A user may interact with other mall shoppers, in real time or on a time delay, and may include seeking the best deals in groups, or “resting” virtual feet at a food court while catching up on the latest gossip or entertainment news.

Further, according to an aspect of the present invention, information regarding the user may be resident within the avatar of the present invention. This user and/or expertise information, as discussed above, may be used to populate a store or mall, wherein the stores offerings may be directed to the user profile associated the shopping avatar, or wherein the store provides offerings based on areas of expertise of the avatar of the storefront “owner.” For example, if user is interested in cars, such as European sports cars, for example, and this information is associated via the widget with the avatar, an automotive store may be provided by the mall to that user, with the “shelves” stocked with virtual and/or real/world parts for European sports cars, or cars, or car auctions, for example. Additionally, the sports car store may be an offering by a qualified expert in such cars, and as such, the user avatar may interact with an expert, namely the store “owner,” while shopping in the owner's virtual store. That is a user may interact with store personnel while shopping, such as via a chat.

Further, adjacent to the automotive store may be a store directed to another interest of the user. In fact, the mall may be populated with stores that match a user's interests. Such an automated mall or store populator may be provided as a site-building mechanism, More specifically, upon logging into or entering a virtual mall, the user's interest may be assessed, and during a brief pause, certain stores, or an entire mall, may be modified, added, removed, or otherwise populated to match the purchasing interests of the user, and/or for the user's avatar. Such a populator may be linked to the upsell engine discussed hereinabove, for example.

The virtual mall may allow for a user, via the user avatar, to simulate the shopping experience by browsing, searching, downloading, purchasing, and the like, and may provide checkout across multiple stores at checkout.

Controls may be used for moving the avatar about the mall and controlling avatar functions. For example, gaming controls may be configured to control avatar movements. For example, a joystick may be used. Alternatively, a keyboard control may be used, such as using the .uparw., .dwnarw., .rarw. and .fwdarw. keys, for example. The space bar may be used to rotate the avatar, for example. Alternatively, the keys W, A, S and D may direct the avatar through the virtual mall. The virtual mall may also have controls to run so that the avatar can get to stores quickly, or “teleport” to other stores, such as by clicking the mouse, for example.

Staffing, ownership or creation of the online storefront may be related to a person's status in the field to which the products pertain. For example, a user who has a significant experience in the field of cars may have an online storefront for autoparts, as described above.

Searching for a store at the mall, or an expert store across one or more malls, may be similar to searching on the web. The person operating a storefront may be an expert in the field to which the storefront pertains and thus may be subject to known searches as discussed above. The expert search may seek a person having increased level of expertise in searched area, in a particular environment, such as on one or more of the user's social networks, and/or may seek search results in accordance with those results found most useful by other experts, or by others seeking experts. An expert may, by being accorded expert status, be entitled to a storefront affiliated with the products or services with which the master is accorded expert status.

In fact, an expert may have multiple pages available for linking to upon searching, and may also have multiple online storefronts related to products or services to which the user is an expert. Each such page and/or storefront may relate to a different topic or area for searching, and therefore each such page may merit a different expertise rating for the user having such pages. Links from homepages, search results and storefronts may be available via navigation in an between such information sites.

A storefront or mall associated with an expert, in accordance with the present invention, may thus allow for keyword based searches to be performed in one or more search environments and/or on one or more computing communities, and/or or across one or more computing communities, i.e., social networks. Such a search may provide the traditional keyword search results, and may also provide links to an expert webpage or storefront, for example.

The expertise attribute, and other attributes, may either be entered by the user correspondent to the virtualization to which the expertise rating is assigned, or may be assigned algorithmically, such as by the computing community or across multiple computing communities, multiple malls, or the like. Thus, the management, creation and selling of products related to expertise via an online storefront may be algorithmically assigned. For example, as a certain user obtains ever increasing positive feedback, or as a certain user is returned more frequently responsive to a search for expert in a certain area, the rating associated with that user's storefront(s) may increase. Alternatively, a user may submit external information to a computing community to prove that user's level of expertise, and the computing community may respond in kind by assigning a particular level of expertise to that user.

Additionally and alternatively, experts in particular fields may advertise their expertise, individually or through their own storefronts, such as wherein an expertise level has been verified by the computing community, mall, or the like, and a searching user may search such “advertisements” in order to locate an expert storefront in a particular field.

Thus, the present invention, at least in part, may provide searching based on the relevancy of a storefront to a desired topic on which a purchase is sought, rather than the prior art methodology of keyword searching relating not to storefronts, but instead relating merely to websites, things, or advertised services that have no expertise rating associated therewith. Of course, this embodiment of the present invention allows the keyword revenue model of prior art search engines, such as Google®, to be employed in the monetization of searching for expert storefronts that can assist with topical purchases for avatar items or real world items associated with the particular keywords searched. Programming for the virtual mall and individual storefronts may be constructed in any programming language and may include any formatting as would be understood by those skilled in the art. Further, such programming may reside on a server or server network, via a locally run widget, or any combination of programming schemes. Storefronts may also be linked to existing e-commerce websites, or webstores. For example, the simulated virtual mall may take the form of an online interactive platform resident on a server network, and it may include various storefronts for users to enter and interact with each other via their avatars. In certain embodiments, there may be an unlimited number of storefronts within the virtual mall. In other embodiments, the number of storefronts may be limited. In either case, the operator or “owner” of the virtual mall may optionally “lease” available space for a storefront, and a user may place their own storefront into the available space for a period of time, such as via a locally run widget. It should be appreciated that the virtual mall and any storefronts therein may conduct business in the same manner as a real world mall, and thus a virtual micro-economy may be constructed as desired by the virtual mall and storefront operators, individual users, and user groups.

It should be appreciated that the shopping experience within the virtual mall environment may include any product transaction mechanism, including point-of-sale, auction-style bidding, bartering, raffle or prize-winning, and may further include any indirect or intermediary component, person, avatar or entity as would be understood by those skilled in the art. Transactionable items may include new and used items, virtual and real world items, virtual and real world services, or any combination of such goods and services.

For example, the virtual mall may include an auction storefront, which may be a generic auction site, or may be a branded site, such as an “eBay® store”. A user, via his or her associated avatar, may enter the store and select virtual and/or real world items to bid on for purchase, or new or used items, or to place virtual and/or real world items up for auction, just as a user would at a brick and mortar auction or online website. In certain embodiments of the present invention, a user may access “masters” or “experts” associated with the subject items, to find the best or most competitive values or pricing points for those items, to find suggested auctions or items for purchase, or to review such items for quality, or any other informational aspect that might be useful to the user and his or her avatar. In other embodiments, the auction storefronts may associate data indicative of incoming bids for items, or the remaining time before the auction closes, with a user or the user's avatar. This would allow the user or avatar to obtain real-time data for the items they are bidding on or selling without having to be “physically” present within the auction storefront, just as a real world user would be able to receive email or text updates on their auctions without having to be logged onto the auction website. Further, stores, auctions, or the like may be recommended to a user based on the user preferences associated with the avatar.

In another example, the virtual mall may include an intermediary merchant storefront, similar to a department store or the online Amazon.com® website. These storefronts may either sell third party branded, virtual and/or real world items, or they may re-brand or dual-brand such items for their own marketing purposes. These items may be new or used, for example. For ease of use, such storefronts may be linked to their existing webstores, or to other third party webstores, such that the users may effectively browse and shop with greater variety while remaining within the same “storefront”.

In yet another example, the virtual mall may take the form of a marketplace, where virtual and/or real world goods may be traded between users via their avatars. Of course, such trading may include any form of virtual or real world currency, credit, or reward or loyalty points, or any other valuation mechanism, in combination with the items exchanged in the marketplace. Thus, it should be appreciated that the “marketplace” may utilize any of the transactional mechanisms of commerce, as described hereinthroughout.

The avatar may also be a vehicle for artistic expression, whether expert or novice in nature. An artistic expression may involve any media or other information that may be associated with the avatar in a visual and/or audible manner by a user of the present invention. The media may be placed in association with an avatar, either at least partially on the avatar representation, or in proximity with the avatar. When placed on the avatar, the media may be incorporated into an aspect of the avatar which may include, for example, the clothing and/or accessories of the avatar. If placed in proximity to an avatar, the media may take the form of background and/or theme for the avatar.

In an embodiment of the present invention, the associated media may allow for display of the media within a discrete portion of the avatar. Media may include still or moving visual, audio, or audiovisual works, documents, links, and the like. For example, a discrete portion may include the body of the avatar, a shirt and/or pants associated with the avatar, and/or an accessory associated therewith. The media may also be restricted to the discrete portion, or may occupy both the discrete portion and a portion of the surrounding area. By way of example, a particular media may be displayed within the confines of a shirt area that may be associated with an avatar. The media may be cropped to fit within the discrete portion correspondent to the shirt. In other words, with or without cropping, the media may be placed within the discrete portion, such as all or a portion of the media showing that is viewable within the space provided by the discrete portion.

For example, media including a picture of the 2008 World Series trophy, held by the Philadelphia Phillies, may be placed on a shirt associated with an avatar. The native picture may, for example, show the trophy held by several members of the team in the Phillies' clubhouse. When placed within the confines of the shirt, the picture may be limited to the area of the shirt and may be adjusted by the user to expose only the trophy and its proximate area of the photograph, for example. Similarly, the photograph may be cropped or reduced in size to more appropriately displayed within the shirt.

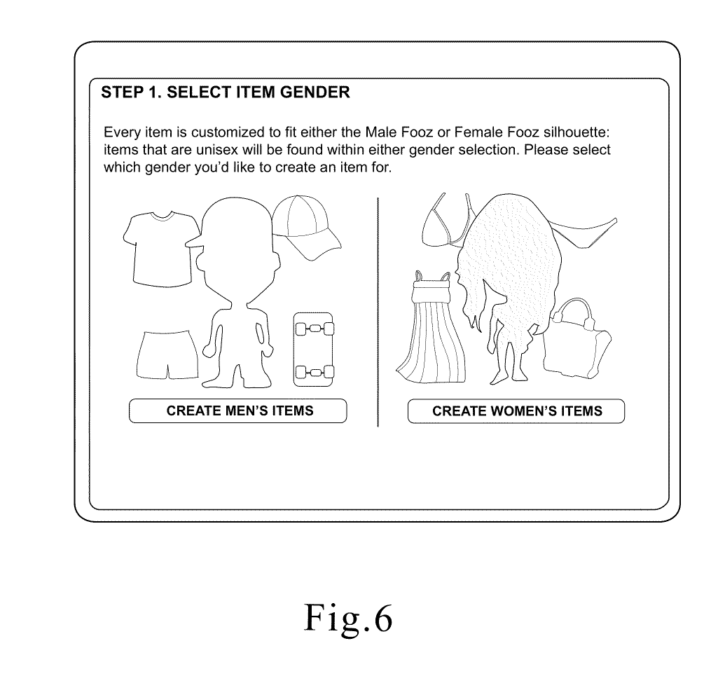

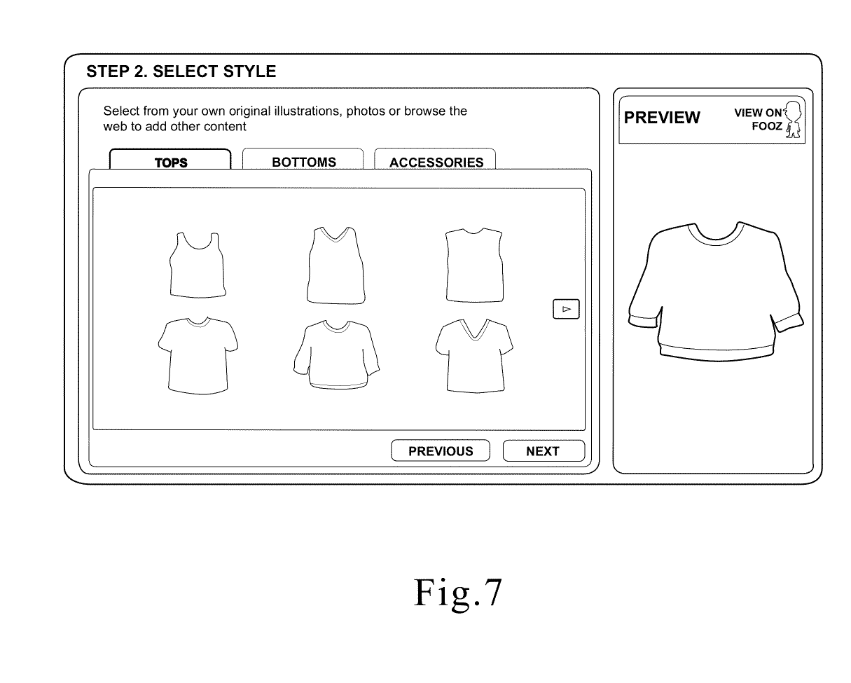

As illustrated in FIG. 6, a user of an avatar may be provided the option of creating a good for an avatar. The user may be asked to choose, for example, if the avatar is male or female. FIG. 7 illustrates options that may be available for a male avatar. In a simplistic offering, a user may choose from tops, bottoms, and/or accessories. Any selected item may be more fully displayed in a provided preview window. Such a window may allow for a more robust display of the item to be created and may allow for the inclusion of an avatar in the preview, as will be described in more detail hereinbelow.

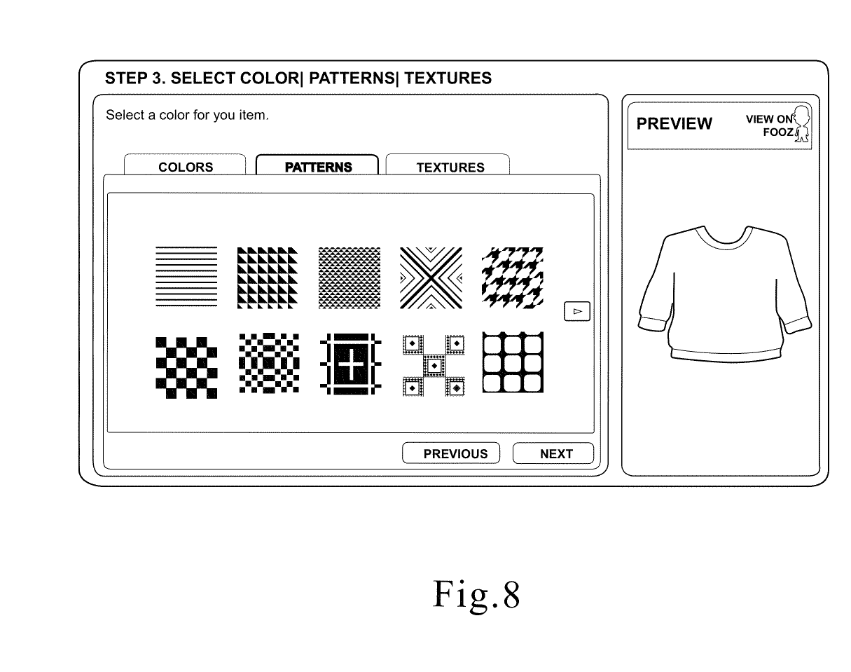

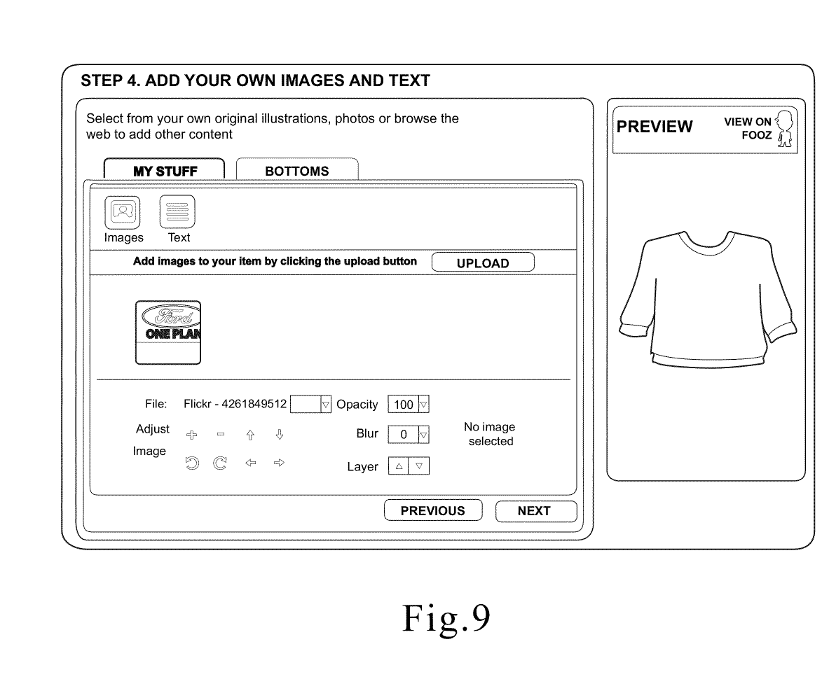

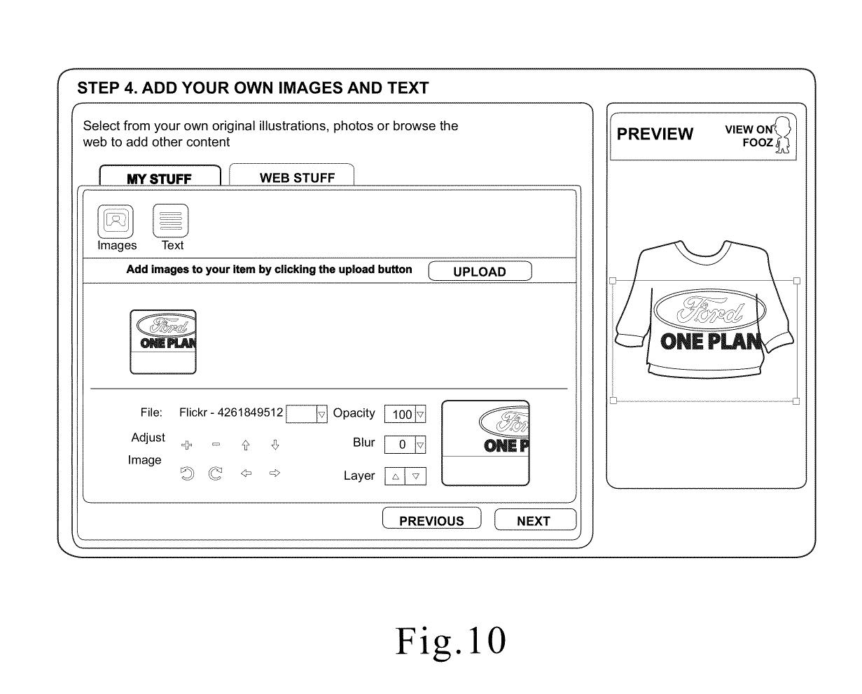

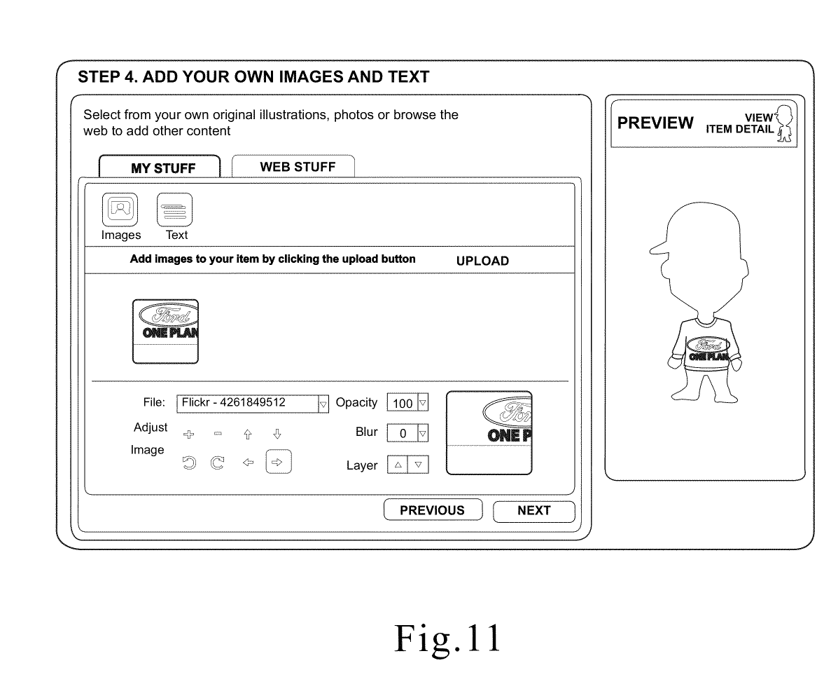

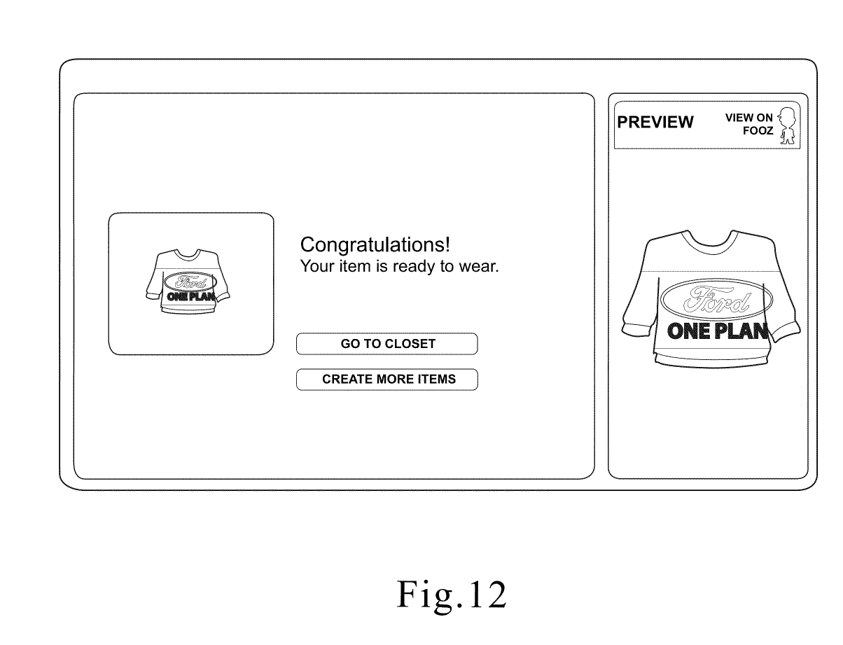

As illustrated in FIG. 8, the item may be provided with colors, patterns, and/or textures. In this way, the user may choose from a wide palette of aesthetic offerings to customize the good. In addition, and as described with greater detail hereinabove, media may also be placed within the good. As illustrated in FIG. 9, the user may select and modify any media to be placed in association with the good. As discussed above, and as illustrated in FIG. 10, media may, for example, be placed and automatically or manually cropped within the good. As illustrated in the preview window, the media shown may be limited to the visible area of the sweatshirt. Media that may otherwise fill the space denoted by the drawing square may be anchored by the small solid squares. Once completed, as illustrated in FIG. 11, the item may be displayed on an avatar representation. This feature may be used on a user's avatar, and may also be exported or “tried on” by other avatars that wish to obtain the good. The goods may also be placed in the user's account, as illustrated in FIG. 12.

In an embodiment of the present invention, media taking the form of video and/or other live action media may be positioned within or proximate to an avatar and/or its clothing/accessories. By way of example, a video of a car driving on a winding road may be used as the background for the avatar and may play while the avatar is displayed. In accordance with known techniques, the media may be stopped and/or paused at any point by providing a control button and/or by setting of user defined parameters, such as based on run time or bandwidth capacity attributes, for example.

The use of media in association with an avatar, as discussed above, may also allow for the creation of clothing and accessories for avatars that may be provided to any avatar, including that of the designing user. Such creations may be made by any user, whether or not the user has expertise in the area. Media used may include self created items or third-party creations. Media may be obtained for use from any location available to the user, such as a media drive, social network, media sharing site, and the like, for example. As previously mentioned, video, pictures, documents, web links, text, animation, RSS feeds, live broadcast, and the like, alone or in combination, may be used as media. Additionally, drawing and writing tools may be used in conjunction with the media to add additional items, such as text and other drawing objects known to those skilled in the art.

Novice users may create clothing within their own respective avatar, or within a control framework. A novice user, for example, may be provided a blank shirt which may be associated with media of choice. The shirt, by way of further example, may also allow for the media to be displayed only within the confines of the shirt. In this way, the user need only import and position the media using drag and drop functionality, for example. Similarly, a novice user may also be provided the ability to crop or otherwise adjust the media to more appropriately fit the intended purpose. Continuing with the example, the shirt may be provided such that the media may be added before or after the shirt has been added to the user's avatar. Similarly, once created, a novice user may store or offer to others a creation. For example, a novice user may design a shirt with her picture on it, and with a writing of “Happy Birthday,” for presentation to another user as a gift.

An expert user, as that term is used herein, as well in related U.S. patent application Ser. No. 12/628,031, incorporated herein by reference in its entirety, may have access to the additional functionality over that of a novice user, including the creation of storefronts and the creation of custom avatar products. An expert user may be provided the ability to create custom clothing and accessories, such as, for example, various sized and designed templates that allow for the placement of media, and/or for the generation of fully incorporated items. Custom templates may take numerous forms and may allow the expert user to create a variety of styled items with custom media effects. Such effects may allow for the setting and/or control of media attributes associated with each item. For example, the item may only allow for static pictures to be placed in association with the media, and/or may allow the user to make the media grayscale.

Users, and preferably expert users, may be provided the ability to sell developed goods, through storefronts and/or other virtual sites, to other users. As discussed above, the saleable goods may range from blank templates to fully designed and operational custom clothing and accessories. For example, an artist may develop an avatar clothing line utilizing her art collection as a theme for the design and/or structure of the custom clothing and accessories. These may then be sold under the designer's name, for example, to identify the source of the goods. Each seller may be provided her own ‘storefront’ within a virtual mall or app store.

For example, a pro sports league may qualify as an expert user and may wish to provide jerseys for sale to users. One or more team storefronts may be created and may contain avatar custom clothing and accessories that would allow a user to dress her avatar in team gear. For example, a user could purchase for her avatar a home jersey of her favorite team and/or player. A user could also, for example, purchase a helmet or a background representing the team's logo. Furthermore, a pro team could make limited and/or special edition custom clothing and accessories available, such as for special events or commemorations. For example, a championship game jersey may be offered for sale. Such a jersey may allow for the display of the championship game as a live or taped full video feed, or as highlights once the game is complete, for example. Such a jersey could have other attributes, such as, for example, an expiration date which would allow for the discontinuation of any video feeds or rights over the previously viewed content. In this way, the seller of such a good may more closely control the distribution and support for certain products. In addition, controls over media, such as copyright enforcement mechanisms, as would be understood by those skilled in the art, may be included with the custom items discussed hereinthroughout. In addition, an expiration date, which may similarly extend to all the custom clothing and accessories discussed hereinthroughout, may allow for the updating of media controls, and may allow for the addition of such controls as required.

Those of ordinary skill in the art may recognize that many modifications and variations of the present invention may be implemented without departing from the spirit or scope of the invention. Thus, it is intended that the present invention covers the modifications and variations of this invention provided they come within the scope of the appended claims and their equivalents.

What is claimed is:

1. A computer-based method for designing one or more virtual items for association with one or more avatars, the steps comprising:
providing a networked server;
providing a computer networked to said networked server;
wherein said computer has a display;
wherein said server is comprised of a software-based creation tool and a software-based online marketplace;
accessing by a user, using said computer, said software-based creation tool and said software-based online marketplace;
displaying one or more avatars on said display, the one or more avatars comprising a virtual likeness of said user;
displaying an item and a background, wherein said item and said background are associated with said one or more avatar;
incorporating, at a direction of a said user, one or more media with at least one of the item and the background;
previewing the incorporation by said user;
accepting the incorporation by said user; and
executing the incorporation based on the acceptance by the user;
wherein said item is obtained in said online marketplace;
wherein said display of said avatar is presented as a virtual trading card;
wherein said virtual trading card comprises one or more sides;
wherein said user is designated as a novice or an expert;
wherein said designation as said novice or said expert provides said user with different options within said online marketplace.

2. The computer-based method of claim 1, wherein the item includes at least one article of virtual clothing.

3. The computer-based method of claim 1, wherein the item includes at least one virtual accessory.

4. The computer-based method of claim 1, wherein the background is selected from the group of backgrounds consisting of: a solid color and a pattern.

5. The computer-based method of claim 1, wherein said one or more media is incorporated with the background.

6. The computer-based method of claim 1, further comprising the step of: saving said accepted incorporation to an avatar profile.

7. The computer-based method of claim 1, further comprising the step of: publishing said accepted incorporation to a user defined location.

8. The computer-based method of claim 7, wherein the user defined location comprises a virtual storefront.

9. The computer-based method of claim 7, wherein the user defined location comprises a profile of an avatar.

10. The computer-based method of claim 1, wherein the one or more media is visually limited to the item.

11. The computer-based method of claim 10, wherein the one or more media is cropped within the item

12. A computer-based method for designing one or more items for association with an avatar, the steps comprising:
providing a networked server;
providing a computer networked to said networked server;
wherein said computer has a display;
wherein said server is comprised of a software-based creation tool and a software-based online marketplace;
accessing by a user, using said computer, said software-based creation tool and said software-based online marketplace;
displaying an avatar, the avatar comprising a virtual likeness of a said user;
displaying an item associated with the avatar;
incorporating, at a direction of a user, one or more media in association with the item;
previewing the incorporation;
accepting the incorporation by said user;
executing the incorporation based on the acceptance by the user;
wherein the item is stored in association with an avatar associated profile and is selected by the user for association with the avatar after acceptance;
wherein said item is obtained in said online marketplace;
wherein said display of said avatar is presented on a virtual trading card;
wherein said virtual trading card has one or more sides;
wherein said user is designated as a novice or an expert;
wherein said designation as said novice or said expert provides said user with different options within said marketplace.

13. The computer-based method of claim 12, wherein the item includes at least one article of virtual clothing.

14. The computer-based method of claim 12, wherein the item includes at least one virtual accessory.

15. The computer-based method of claim 12, further comprising the step of publishing the accepted incorporation to a user defined location.

16. The computer-based method of claim 15, wherein the user defined location includes at least one virtual storefront.

17. The computer-based method of claim 15, wherein the user defined location includes a profile of said avatar.

18. The computer-based method tool of claim 12, wherein the one or more media is visually limited to the one item.

19. The computer-based method of claim 18, wherein the one or more media is cropped within the item.
